(19) United States
(12) Patent Application Publication
(10) Pub. No.: US 2015/0269138 A1
(43) Pub. Date: Sep. 24, 2015

(54) Publication Scope Visualization and Analysis

(71) Applicant: Edanz Group Ltd., Fukuoka (JP)

(72) Inventors: Richard Michael Parris, Beijing (CN); Kerry Alexander Greer, Fukuoka (JP); Benjamin Edward Shaw, Beijing (CN)

(21) Appl. No.: 14/664,039

(22) Filed: Mar. 20, 2015

Related U.S. Application Data
(60) Provisional application No. 61/968,101, filed on Mar. 20, 2014.

(51) Int. Cl. G06F 17/27

(52) U.S. Cl. CPC G06F 17/2785

(57) ABSTRACT

A system generates visualizations representing publication data for one or more publications. The visualizations present information to support consumer decisions to read, submit, or otherwise interact with the publication. The visualizations may also assist in publisher or other curator decisions related to shaping the content of the publication. In some cases, the publication data may be derived from semantic analysis of the content of the publication or other related publications.

### PRIORITY CLAIM

This application claims priority to provisional application Ser. No. 61/968,101, filed Mar. 20, 2014, which is entirely incorporated by reference.

### TECHNICAL FIELD

This disclosure relates to representing publication information visually. The disclosure also relates to generation of publication information from historical publishing data.

### BACKGROUND

Every year many new journals begin publishing, while existing scholarly and scientific journals greatly increase their output. The publishing focus of existing journals may change and adapt to reflect changes in their field or fields of focus. Journals may update their textual explanation of stated focus, often called the “Aims and Scope” for the publication, to reflect a shift in publication focus as reflected in the content published. Researchers, librarians, administrators, journals editors and publishers attempting to understand the topic and requirements of journals to publish, publish in, purchase and read may use these textual explanations.

### BRIEF DESCRIPTION OF THE DRAWINGS

FIG. 1 shows example fingerprint representations for a publication.

FIG. 2 shows an example vector visualization.

FIG. 3 shows example prism visualizations.

FIG. 4 shows example states of an explorer visualization.

FIG. 5 shows an example expand action on a publication node.

FIG. 6 shows an example visualization displaying the percentage of items published by a publication by type.

FIG. 7 shows an example visualization displaying the frequency of appearance of a term within a base publication or set of publications.

FIG. 8 shows an example visualization showing levels of open-access.

FIG. 9 shows an example visualization comparing a publication's metric value against the average for measured publications and for those classified in the same field or subfield as the publication.

FIG. 10 shows an example visualization showing the relative numbers of papers published by other publications, other publications in the field and a given publication matching either a keyword or sharing a topic.

FIG. 11 shows an example visualization comparing the average previously published papers by authors across all publications, in a publication's field and for the publication.

FIG. 12 shows an example visualization comparing user ratings for various aspects of submitting to and working with a publication.

FIG. 13 shows an example environment for the scope tool.

FIG. 14 shows an example network environment for the scope tool.

FIG. 15 shows an example specific execution environment for the scope tool.

FIG. 16 shows example publishing focus query logic.

### DETAILED DESCRIPTION

The discussion below makes reference to a scope tool for presenting information on publication tendencies within journals and/or other publications. The scope tool may base the information on data from the publication history of the publication. In some cases, the scope tool may use multiple graphical representations to addresses these issues by combining and generating data on journals and presenting it visually to assist understanding and discovery of aspects of a journal. The scope tool may be presented on websites, including dedicated ones. In some implementations, the scope tool may be available as a ‘widget’ that publishers, learned societies, or any other individual or organization, can embed on their website; or available as an application that can be downloaded, or installed locally. The scope tool is a system to provide advanced, rapid, visual understandings of the nature of academic and scientific journals aims and scope by combining various semantic and large data analysis techniques with specialized data representation methods to graphically represent journals' past and present publication focuses and other features of the journal. When embedded as a widget, or downloaded as an AP, the scope tool will be able to interact with the content from that page or others, or via as an API (application programming interface). The scope tool can be customized or opened in multiple ways to a show a particular state. The scope tool may be used for representing the focus, nature and facts of a publication using data collected from multiple sources, processed using multiple techniques. The scope tool may present data in multiple formats to cater for multiple user profiles.

While the techniques and architectures presented are discussed primarily in terms of the example use of improving the understanding of academic, technical and scholarly journals for interested parties, the techniques and architectures described here are also adaptable to other areas, including fiction and nonfiction literature, where the nature and focus of a publication is explained to readers. The scope tool can also be used to reformat non-text items.

The scope tool may plot sets of data values against each other in a variety of interactive graphical tools. These graphical tools may provide information about academic, scholarly and scientific journals in new ways. This technique makes information simple to understand, and promotes discovery of information within data sets that is not possible, or is difficult, with current, mainly text based techniques.

In various implementations, the scope tool may combine structured and unstructured data along with content, abstracted content and meta-data from academic, scholarly and scientific journals and other publications. The structured data is typically provided by journals, editorial teams, publishers, libraries, repositories and other organizations in machine and human readable formats, as well as data generated by user interaction with the scope tool and related corporate and commercial services including submission and publication times, acceptance rates, internal traffic analytics, bookmarking, ratings, and comments. The data can also be generated through monitoring and analyzing the use of the above sources, web sites or material. Unstructured data includes the contents of journals including the text of articles, abstracts and other sections and titles, references, and citations and other links to journals. Data consists of both journal and article data. Journal data describes journals as entities. Article data describes articles as entities.

Data Gathering:

In some cases, the data may be gathered mechanically. Mechanical data gathering techniques include but are not limited to: connections to APIs, FTP or other Downloads, logging RSS and other feeds, web crawling, and accessing public and licensed repositories. Data is also gathered through analysis of website usage, reading materials and other user and consumer behavior. Automated data gathering from subscriptions, feeds, periodic downloads, or other sources may also be implemented.

Data Parsing and Organization:

Data may be stored in SQL, noSQL, and/or other file system databases. Data storage formats may be standardized, and parsed data stored in distributed file systems for rapid retrieval and analysis. Data may be stored in a variety of formats, or structures, including graphs, maps, arrays, as linked data, in indexes, matrices and vector spaces.

Ontologies and Taxonomies:

The scope tool may use manual, software, and mechanically generated, curated, taxonomies/ontologies, disambiguation schemas, authority control, stopwords (words which are removed from text prior to processing) and algorithms. The algorithms used in generating ontologies, taxonomies, topic and field lists are tuned both ‘actively’ through deliberate adjustment planned from observation of results, and from analysis of user interactions with the system and systems within which they are embedded. Existing ontologies and taxonomies may include: PubMed MESH (Medical Subject Headings), SKOS datasets (Simple Knowledge Organization System), The National Aeronautics and Space Agency's Astrophysics Data System (ADS), Education Research Australia's Field of Research codes, The United States Environmental Protection Agency's taxonomical sets.

The scope tool may generate or collect ontologies and taxonomies from text. Examples of this include collecting keywords, institution names from articles in an archive, medical device or reagent lists from suppliers, Institutions mentioned in Articles and other similar sets. Ontology quality can be adjusted using standard de-duplication and synonym detection and matching techniques.

Data Sets:

Data sets can be, e.g., series, maps, or collections or other sets of values. The scope tool combines different methods to generate new data sets from existing data sets.

Extraction:

Data sets can be extracted from other data sets by identifying common characteristics, properties or values in one or more other data sets. Extracted data sets can be saved separately or generated in real time depending on the amount of data involved, time for completion and computational power available.

Mappings:

Data sets can be created by mapping characteristics, properties or values from one or more other data sets in one to one or many to one relationships into a single set. Mapped data sets can be saved separately or generated in real time depending on the amount of data involved, time for completion and computational power available.

Mapping may involve the creation of a correspondence between values in the original data to values in the resultant data. In some cases, multiple values in the original data may be mapped onto a single value in the resultant data. Maps can be machine or human generated.

Mapping allows multiple lists of like or similar items to be compared, ranked, listed or otherwise represented in a uniform manner. Mappings may also reduce the number of values for a particular property. For example, Lists of Journals, Researchers, Articles, Conferences or other objects in the academic sphere use different topic categorization schemes. A mapping function can be used to make such list comparable by mapping of fields in the lists to a standardized set of categories. Mappings may also reduce the number of values for a particular property.

Calculations and Transformations:

Data sets can be calculated or transformed from single or multiple values from single or multiple sources. Calculations can be mathematical functions, string manipulations or other operations that can also be expressed with non-algorithmic code. For example, submission dates from an online system can be correlated to publications dates of articles to provide average time to publication data.

Relational Analysis:

Data sets can be created by graphing relationships within and across other data sets. Journal and Article data contains many data values which represent relationships to objects in other data sets. These include author-paper, author-journal, researcher-institution, citations (paper-paper), publisher-journal, publisher-article, topic-article, topic-journal, editor-journal, editor-paper, reviewer-paper, reviewer-journal, user metrics-journal and by comparing independent metrics schema.

Non-Semantic Text Analysis:

Data sets can be created through analysis of patterns in the formatting of papers. Non-semantic data includes lengths in words or characters of articles, titles or sections of articles, type of abstract required, existence and names of specific sub-sections, article types, text formatting, numbers and formats of figures and tables, numbers and formats of references and type and formatting of formulas and other special text.

Text Analysis:

Data sets can be created using a variety of techniques in semantic computer learning and other forms of text analysis.

N-Grams and Term Frequency:

Data sets can be created by identifying N-grams, multiple character or word sequences, and individual word frequencies within other data sets. Words and n-grams of interest can be identified through mechanical techniques, primarily statistical analysis use of Markov chains, and from within existing ontologies.

Vector Based Techniques:

Vector techniques may be used to create new data sets by analyzing the frequency of terms or sets of terms in text. The analyzed terms can then be considered dimensions in a highly-multi-dimensional vector space.

Topic Modeling:

Data sets can be created by locating other data sets within topic models. Latent and Hierarchical Dirichlet allocation, and other statistical methods can be used to create topic models, from structured and unstructured scientific text corpora. These processes may define ‘topics’ around clusters of spikes, terms appearing with greater than average frequency within units or parts or the corpus.

Data Types:

Data sets created using the techniques discussed here can be categorized into various types or groups.

Topic:

Topic related data sets are concerned with the topic of an object or the academic, scholarly or scientific field into which it falls. Topic properties can be assigned at a variety of ‘resolutions’ with finer or coarser grained differentiation in topic. Multiple topic identifying values can be assigned to objects; for example academics scholars or researchers could be categorized according to various scientific field description schema.

Term and N-Gram:

Term or n-gram data sets mostly relate to frequency of these items within text corpuses. They can also take the form of synonym lists, stop words or lists of words with no correlation to topic.

Temporal:

Temporal data is those properties of objects that relate to time. These typically relate to discovery or publication date but also include non-absolute time values such as time to publication or time to reach 50% of current citations.

Relational:

Relational data can take the form of lists of related identification values between objects within or across data sets. Identification values in relationships are not necessarily unique, strong, identifiers.

Industry/Procedural:

Industry or Procedural data relates to contingent data including Article Types published in a journal, book or by an author, requirement by a journal of a cover letter of explanation to accompany submissions, frequency of a journal, author type for a researcher in a paper etc., formatting requirements or submission URLs.

Data Structures:

Data sets can be stored in multiple structures to optimize query simplicity and time. Data Structures are designed to remove complexity and enhance speed in processing and responding to queries.

Data structures can be stored concurrently on machines, distributed over multiple machines or individually on multiple connected machines.

Data structures are stored in a variety of formats including graphs, maps, arrays, as linked data, in indexes, matrices and vector spaces.

Data Representation:

Data representations within the scope tool help locate patterns, correlations, singularities, irregularities and other markers in the data. This is achieved by various techniques including filtering, zooming and panning, feedback models (creating bonds of differing strength between objects to model their relationships) and linking.

The data representations in the scope tool also interact with each other in that the results or selections in from one can be input into another. An example being that keywords identified in one scope tool instance could be used as groupings in another instance.

In various implementations, the scope tool may use a collection of ‘visual representations’. These can be navigated between and feed information to each other within the scope tool.

‘Fingerprint’ Visualization:

Visualizations which may include, visual, interactive representations of the frequency and relationships of topics or ideas within a publication, may be generated by the scope tool using virtually any of the above discussed analysis techniques and inputs. The visualization is generated from a word or N-gram data set. Terms shown are selected as the most common within the full text content for the publication that appear in an ontology of ‘meaningful’ or field indicative′ terms and are not excluded as ‘stopwords’.

Distance between the terms indicates how frequently the terms appear together in the same text. Terms that are regularly found in the same article, abstract or item are placed closer together, terms that are not found together or are seldom found in the same article, abstract or item are placed further apart.

Interactions with the fingerprint visualization include changing focus, removing items and zooming and panning to gain better resolution in areas of interest.

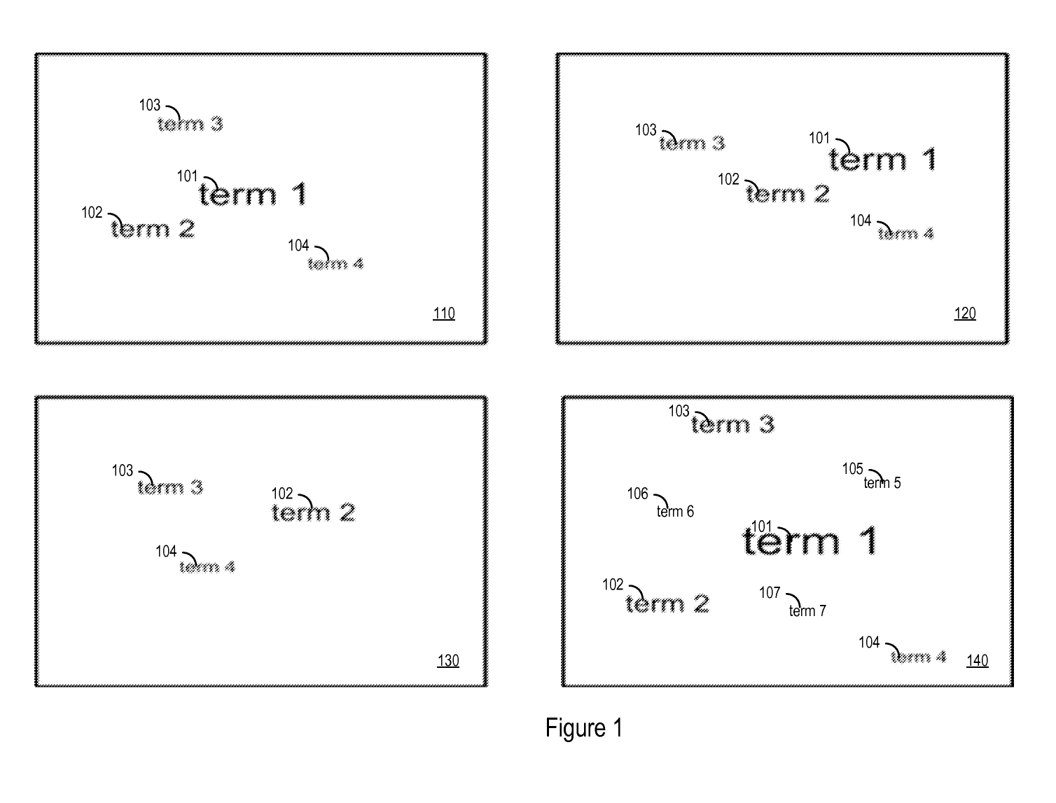

FIG. 1 shows example fingerprint representations 110, 120, 130, 140 for a publication. The number of terms 101, 102, 103, 104, 105, 106, 107 shown may range between 6 and 20. However, virtually any number of terms may be shown within a fingerprint representation. In some cases, the size of the visualization may be adjusted to incorporate more or fewer terms. An example ‘refocusing’ event 120 performed on the example representation 110 is shown. In the example, the refocusing event is that Term 2 102 was selected, e.g., in response to user interaction with the display, to become the ‘focus’. An example ‘removal’ action 130 may also performed on the example representation 110. In the example, Term 1 101 has been removed, e.g., in response to user input, from the example fingerprint visualization 130 and the remaining items have ‘resettled’ or re-mapped within the space of the visualization 130. A example ‘zoom’ action 140 on the representation in 110 is also shown. Zooming in increases the linear distance between terms and shows less frequent terms, e.g., terms 5, 6, and 7 105, 106, 107 that fall within these spaces. Similarly, zooming out decreases the linear distance, less frequent terms may be dropped from the visualization. In some cases, the relative sizes, e.g. font sizes, of the terms may indicate their relative frequencies of occurrence. Thus, zooming in and zooming out may result in adjustments to the displayed size of terms to maintain the relative ratios as less frequent terms are added or removed from the visible layer.

‘Vector’ visualizations may include visual, interactive representation of the frequency of topics indicators or ideas within a publication or set of publications. The visualization may be generated from a word or N-gram data set. Terms used in the visualization can be selected by the user, fed from another part of the scope tool or suggested as the most common within the full text content for the publication that appear in an ontology of ‘meaningful’ or field indicative terms and are not excluded as ‘stopwords’.

Interactions include changing time scale, looking at different topic ‘resolutions’, e.g. scientific fields, general topic descriptors, specific topic descriptors or keywords and changing classification systems or ontologies.

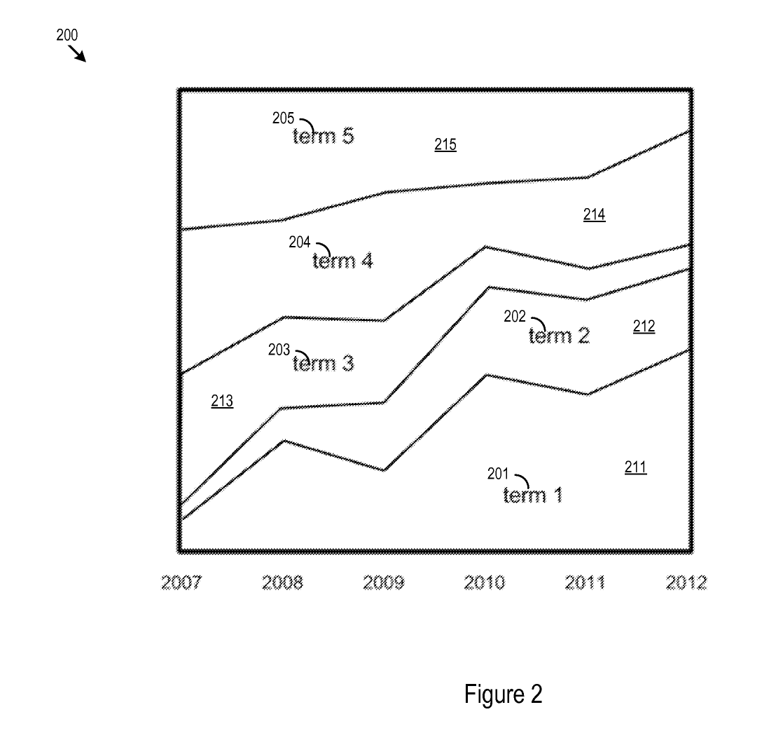

FIG. 2 shows an example vector visualization 200. The terms 201, 202, 203, 204, 205 occupy different regions in the visualization 211, 212, 213, 214, 215. The width of the individual regions 211, 212, 213, 214, 215 representing the relative prevalence of a term versus time. In some cases, a vector visualization may assign individual colors to the regions to clearly demarcate the regions. The example vector visualization shows an increase in the prevalence of term 1 201 and term 2 202 in the relevant publication or publications between 2007 and 2012 and corresponding drops in the prevalence of term 3 203 and term 5 205, while term 4 204 is roughly constant. This indicates a change in focus from the topics represented by terms 1 201 and 2 202 to from that represented by 3 203 and 5 205.

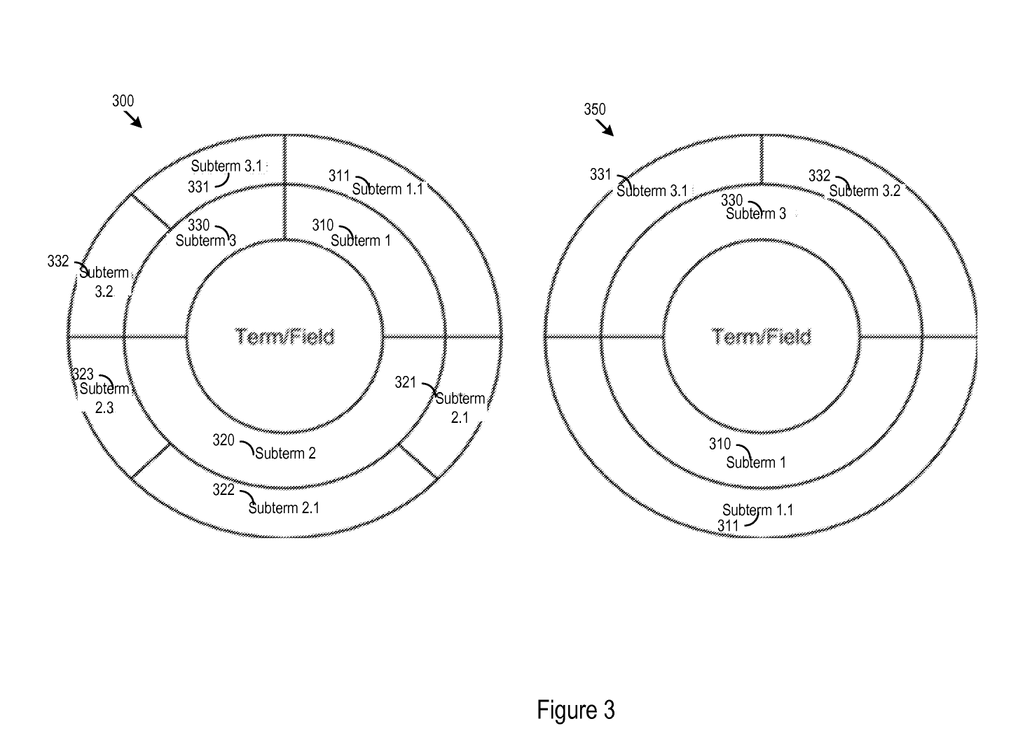

‘Prism’ visualizations may include interactive, hierarchical, representations of topic profile of a publication or any other form of publication. The visualization may be generated from a hierarchical word or N-gram data set from one or more publications. In FIG. 3 the hierarchy is represented by concentric discs with the ‘top’ or head of the hierarchy at the center and with child layers shown sequentially as layers from the center. The area occupied by the terms in its layer is proportional to its frequency in the text for the relevant publication or publications. This visualization could also be presented as a tree, pyramid or any other hierarchy that shows relative sibling sizes. Terms used in the visualization can be selected by the user, fed from another part of the scope tool or suggested as the most common within the full text content for the publication that appear in an ontology of ‘meaningful’ or field indicative′ terms and are not excluded as ‘stopwords’. The ‘top term’ in the hierarchy can be suggested or user selected.

Interactions include rotation and ‘cut away’ of topics covered in a publication or any other form of publication to understand the profile of a sub-area. Rotation interaction is not pictured.

FIG. 3 shows example prism visualizations 300, 350. The prism visualizations 300, 350 show an example term set represented hierarchically in the scope tool. The full example term set is shown prior 300 to an example cut away action 350. The hierarchical relationship shows parent and child sub terms from a central term. The parent sub terms 310, 320, 330 may be broad terms that encompass the child terms 311, 321, 322, 323, 331, 332. Multiple hierarchy levels may be shown.

In the example ‘cut away’ action, Sub Term 2 320 is removed along with its descendants, Sub Terms 2.1, 2.2, and 2.3 321, 322, 323 from the hierarchy. The remaining items are then resized to their relative sizes in the remaining set in the scope tool 350.

This allows for a multi-disciplinary journal or any other form of publication to be considered within one of the fields it contains by excluding the others. General subject or topic journals such as Nature, PLoS or Science can be viewed at a ‘Physics Journal’ or ‘Medical Journal’ by deselecting other topics.

These sets of topic identifiers can be selected or sourced from other tools in the scope tool.

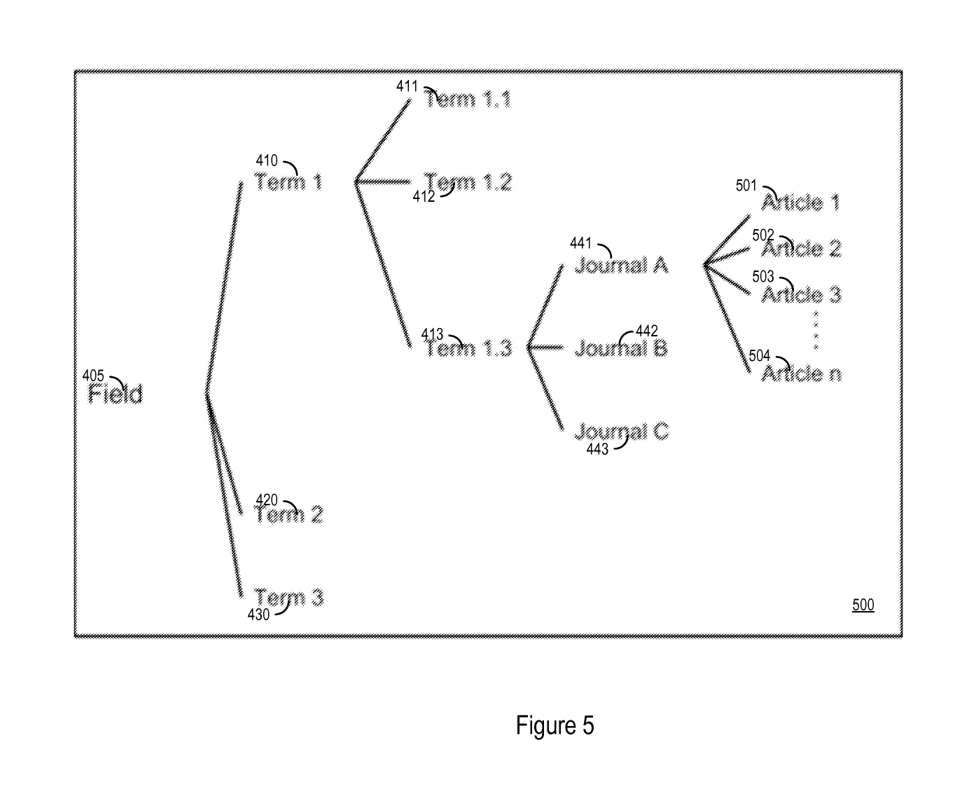

‘Explorer’ visualizations may include an interactive visualization for location and discovery of journals, or any other form of publication or product, and content. The visualization is generated from a hierarchical word or N-gram data set from one or more Publications. In FIG. 5 the hierarchy is represented in a tree format. This visualization could also be presented as a circular model as per FIG. 3, pyramid or any other hierarchy that can be expanded. Terms used in the visualization can be selected by the user, fed from another part of the scope tool or suggested as the most common within the full text content for the publication that appear in an ontology of ‘meaningful’ or field indicative′ terms and are not excluded as ‘stopwords’. The ‘top term’ in the hierarchy can be suggested or user selected.

The interaction for the visualization is to ‘expand’ a node. Expanding a node exposes children. This allows navigation from the primary node expanding chosen subfields to locate journals or any other form of publication and articles by topic. Journals or any other form of publication and articles shown within the structure can be filtered and ordered on selection criteria including, access model, publisher, time to publication information, publication date, ratings, and selections made elsewhere in the system or in systems in which the scope tool is embedded.

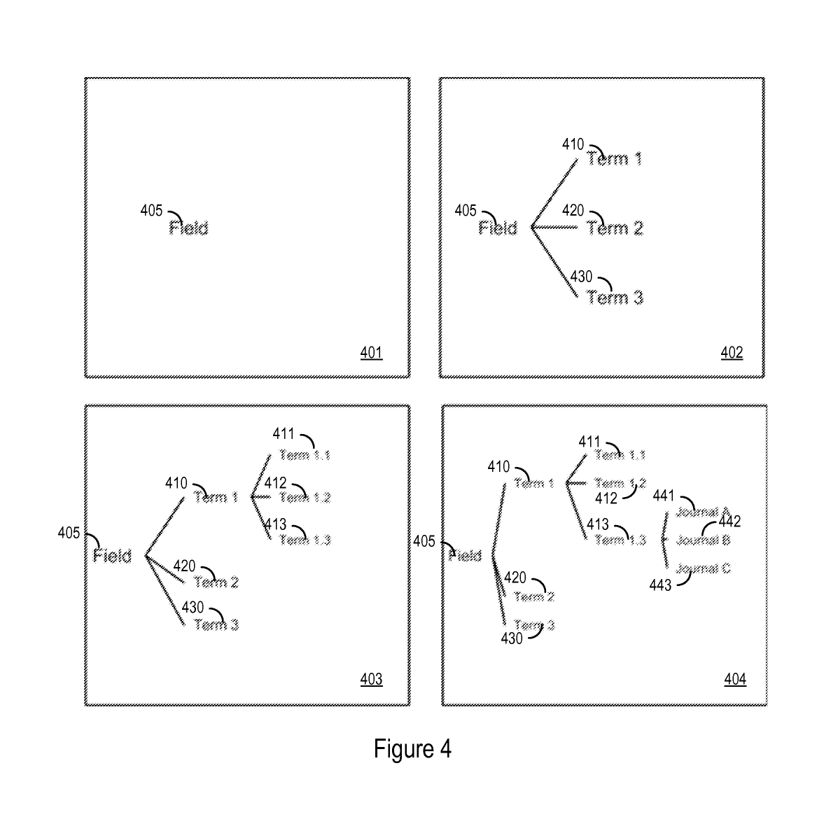

FIG. 4 shows example states 401, 402, 403, 404 of an explorer visualization. In the explorer's initial state 401, a field 405 for a publication may be shown. For example, a user may select a topic from a publisher webpage and be presented with an explorer visualization for the selected topic. An example result of an ‘expand’ action 402 on the root node of the tree may expose children of the root node, e.g., terms 1, 2, and 3 410, 420, 430. A second example ‘expand’ action 403 on the ‘Term 1’ node of the tree may expose sub-terms, e.g., sub-terms 1.1, 1.2 and 1.3 411, 412, 413. After one or more sub-term levels, a user may perform an ‘expand’ action on a node to expose relevant journals or other publications. In some implementations, expand actions may expose increasingly narrow sub-terms. Relevant publications may be exposed by selection a publication action. However, in the example shown an expand action 403 exposes Journals A, B and C 441, 442, 443.

FIG. 5 shows an example ‘expand’ action 500 on a publication node. The expand action 500 exposes articles 501, 502, 503, 504 related to the terms selected in the tree with previous ‘expand’ actions e.g., example expand actions 402, 403, 404.

Other Visualizations.

Visualization showing content by publication type. Datasets can be gathered directly from article meta-data or from analysis of article characteristics. Data for this visualization is gained from parsing and comparing of industry lists, crawling of web-sites and other sources as described above for ‘Industry/Procedural’ data.

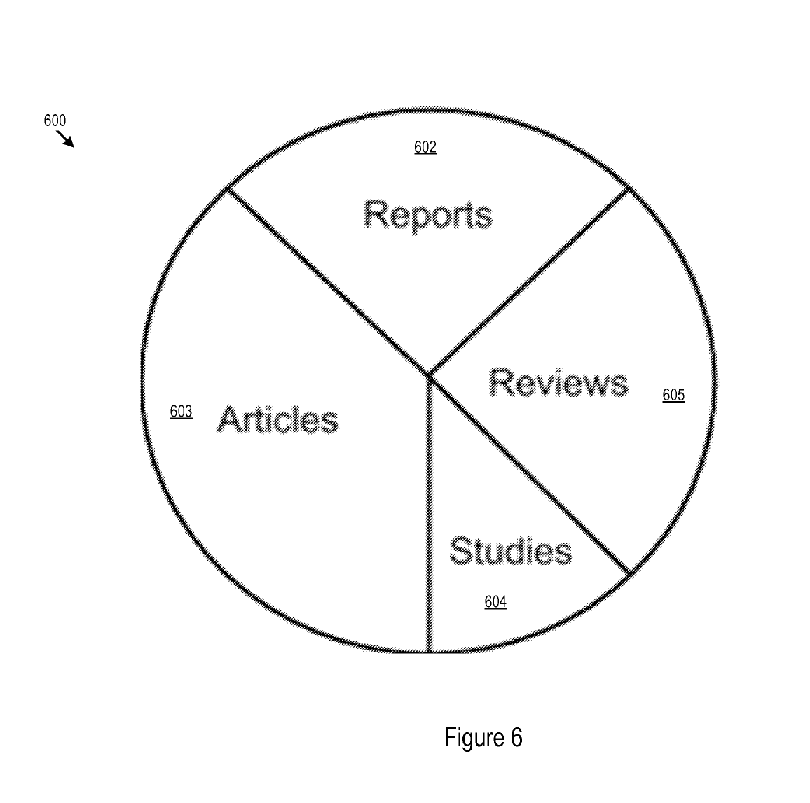

FIG. 6 shows an example chart 600 displaying the percentage of items published by a publication by type. The example types include reports 602, articles 603, studies 604, and reviews 605.

Visualizations may show concept uptake speed. A concept uptake visualization may generated from a word or N-gram data set by the scope tool. Terms used in the visualization can be selected by the user, fed from another part of the scope tool or suggested as the most common within the full text content for the publication that appear in an ontology of ‘meaningful’ or field indicative′ terms and are not excluded as ‘stopwords’.

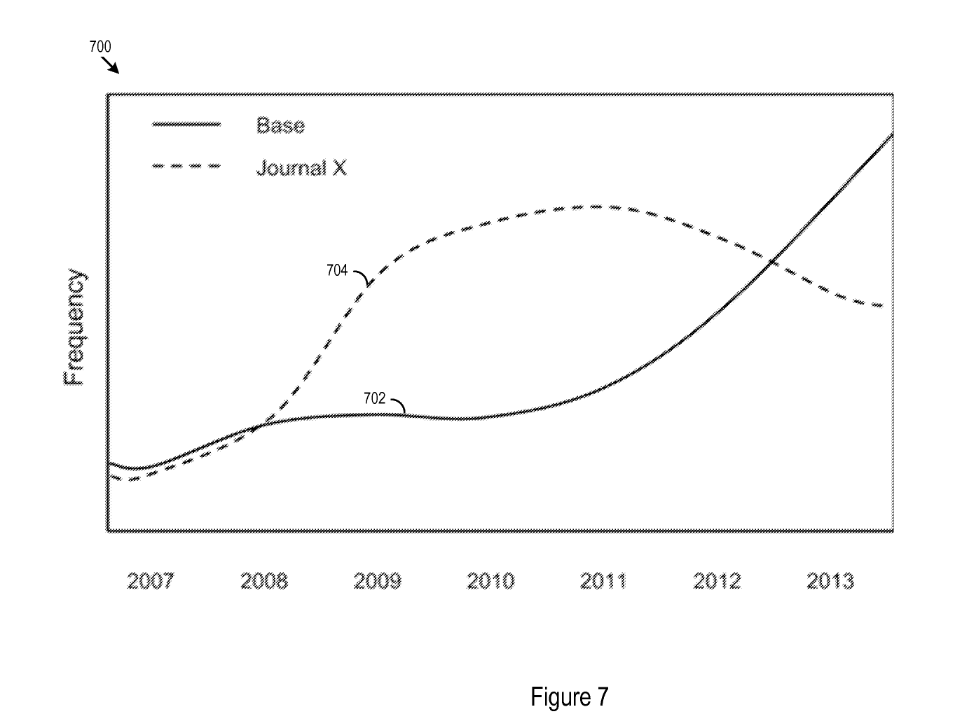

FIG. 7 shows an example visualization 700 displaying the frequency of appearance of a term within a base publication or base set of publications 702. New terms may appear earlier and more often in publications that might be described as ‘progressive’ while ‘conservative’ publications would show a lag in frequency of use of the same terms. A selected publication 704, e.g., journal X, may be compared to the base 702.

Visualizations may show the factors that determine the ‘access model’ for a publication. Data for this the access model visualization may be gained from parsing and comparing of industry lists, crawling of web-sites and other sources as described above for ‘Industry/Procedural’ data.

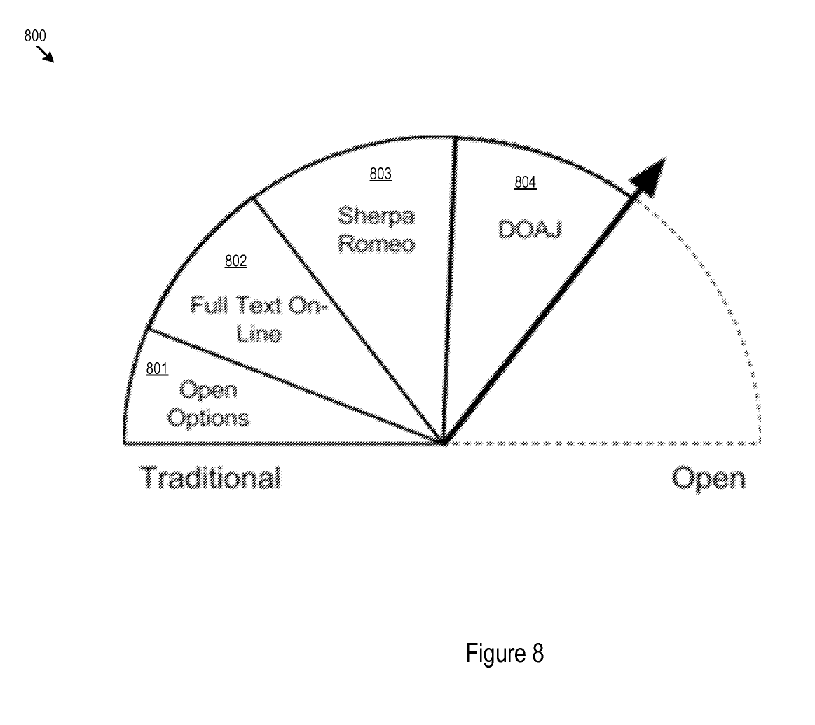

FIG. 8 shows an example visualization 800 showing levels 801, 802, 803, 804 of open-access. A user may select from multiple open access level options 801, 802, 803, 804 and receive publication suggestions. The open access level selection may be merged with field or term-based selections to generate reading or publishing recommendations for a user. For example, a journal may appear in the Directory of Open Access Journals (DOAJ). A publication may be deemed to have open access depending on the level of access readers or authors are allowed in the absence of fees, subscriptions, or other access barriers.

Visualization may show the importance metric. Data on importance metrics, calculations on citation rates and links to articles within publications may be produced by various organizations. Data for this visualization is gained from parsing and comparing of industry lists, crawling of web-sites and other sources as described above for ‘Industry/Procedural’ data.

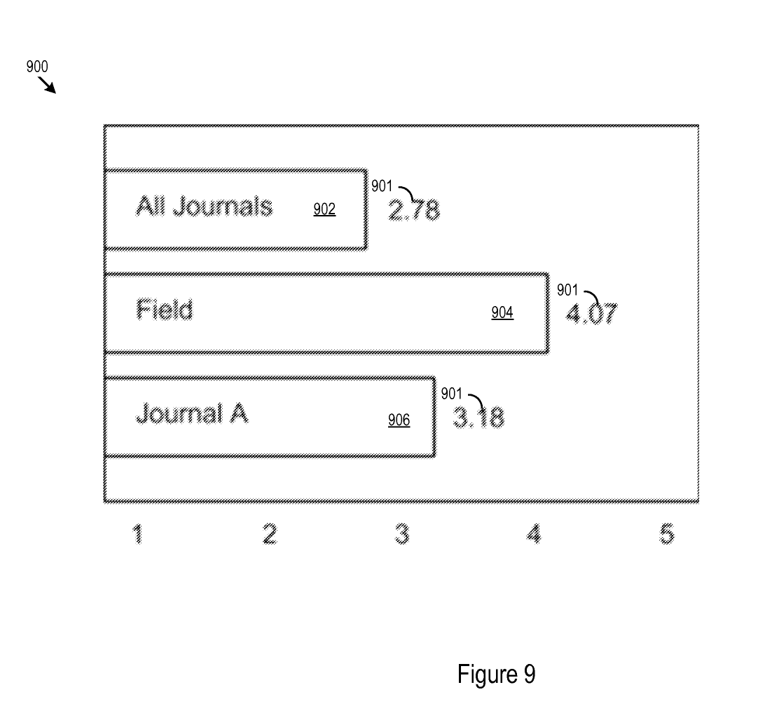

FIG. 9 shows an example visualization 900 comparing a metric value 901 for a publication 902 against the average for measured publications 904 and for those classified in the same field or subfield 906 as the publication.

Visualization may also show the volume of publications available for a given topic or focus. Data for this visualization is generated using a combination of techniques as described in the Calculation and Topic sections above and is sourced from parsing and comparing of industry lists, crawling of web-sites and other sources as described above for ‘Industry/Procedural’ data.

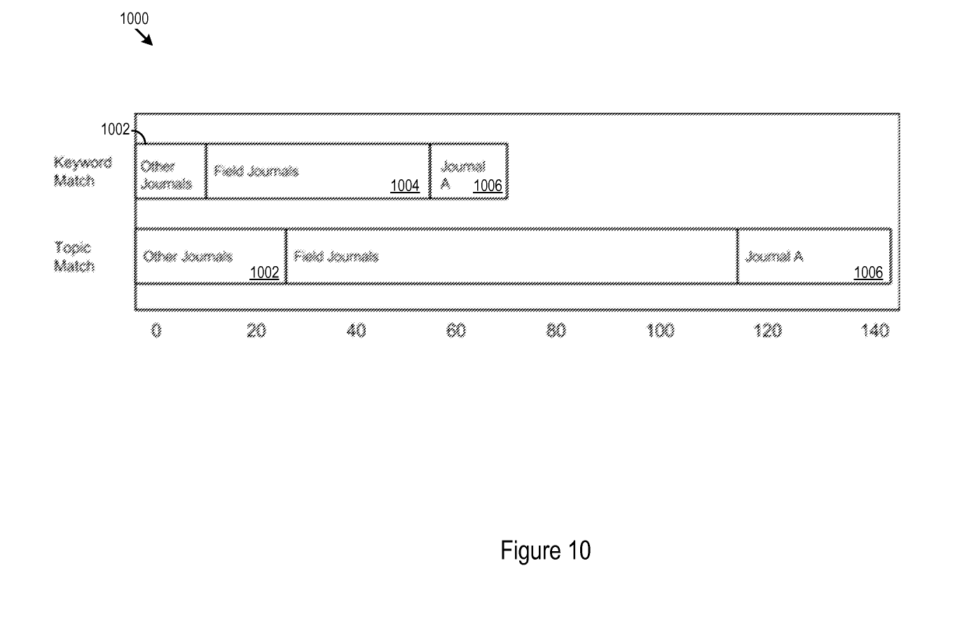

FIG. 10 shows an example visualization 1000 showing the relative numbers of papers published by other publications 1002, other publications in the field 1004 and a given publication 1006 matching publishing focus query, e.g., initiated by a keyword input or publication comparison request.

Visualization showing average number of career papers. Data for this visualization is generated using a calculation (summing) as described in the Calculation section above and relational data that is sourced from parsing and comparing of industry lists, crawling of web-sites and other sources as described above for ‘Industry/Procedural’ data. It also relies on other data sets previously calculated: disambiguation of scientific authors to form a graph of connected unique entities.

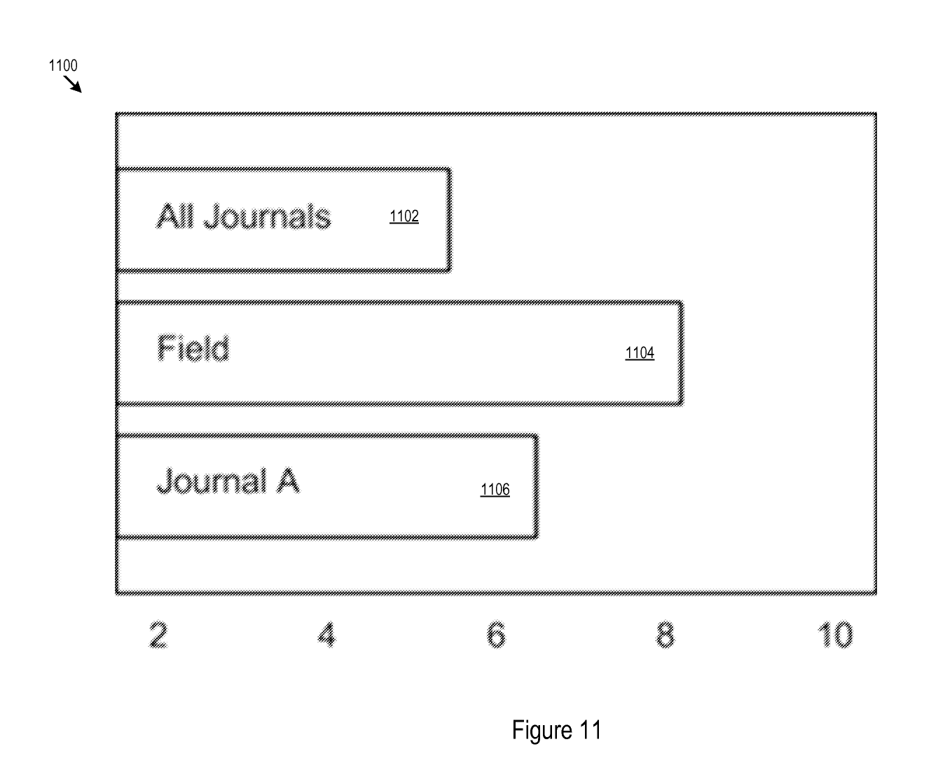

FIG. 11 shows an example visualization 1100 comparing the average previously published papers by authors across multiple publications 1102, in a given field 1104 and for a given publication 1106.

Visualizations may also present representations of user feedback and activity. Data for this visualization is captured from user input and analysis of user activity as described in the Data section above and from calculations and extractions. Time to publication, for example, can be tracked from date of submission in a submission system and publication date. Questions of sentiment can be gathered from Sentiment Analysis and from direct interrogation of users. Items such as quality or clarity of instructions are measured from relative times to complete tasks and from patterns in software usage indicative of confusion.

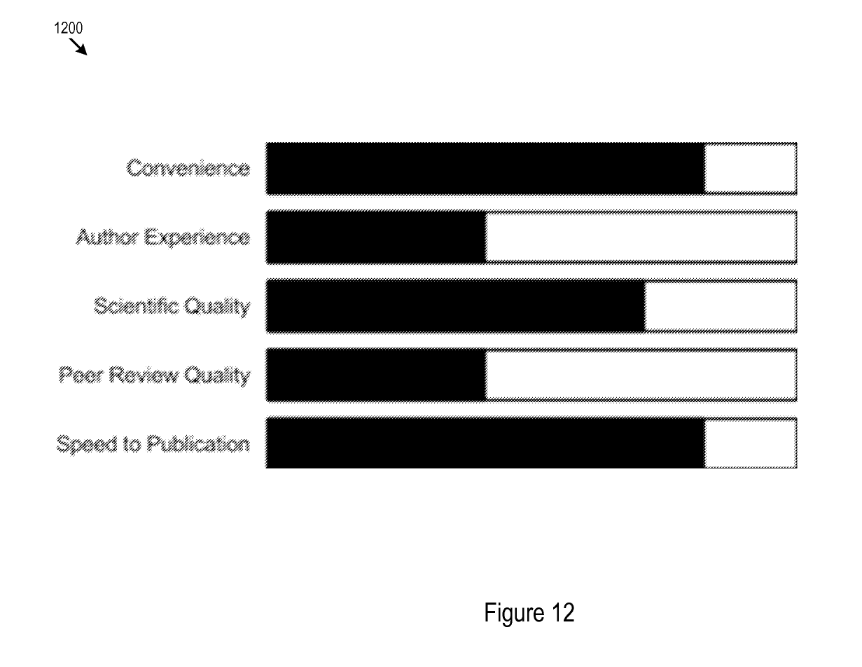

FIG. 12 shows an example visualization 1200 comparing user ratings for various aspects 1202 of submitting to and working with a publication.

Metadata:

In some cases, a display location, e.g., a website, for a visualization may have as associated publication metadata, including Title, URL, Impact Factor and other ratings displayed in an organized fashion. This data includes extended data provided by publishers including video abstracts, purpose statements and editorial statements; user generated data from systems used by readers of and submitters to a journal or any other form of publication; extended curated information of use to interested parties including RSS feeds and other APIs, submission system information, specific URLs for submission, formatting, reviewing and other requirements and guidelines.

Use Cases:

In some cases, the scope tool may be used by individuals interested in publishing in, reading, locating, purchasing, editing, managing or listing journals or any other form of publication.

The scope tool can be used to replace the current text based, descriptive, statements categorized as the ‘Aims and Scope’, that are currently presented by academic and scientific journals, with a suite of interactive tools graphically representing the publication and/or topic focus of journals. Various features of the scope tool also allow for comparison and field specific analysis of multi-field or multi-topic journals. This provides academic and scientific authors finer-grained and more extensive information, in graphical formats, about the specific topics publications relevant to their fields of research are actually publishing. As part of systems where users can list, compare or search for Publications, the scope tool can aid by showing subject trending in a publications' publication focus. It can also enable users to compare and contrast among publications by presenting side-by-side visual representations of multiple publications.

Scientists and researchers, teams, laboratories and institutions can use the scope tool to: discover relevant published research, reduce the time taken, especially by authors for whom English is not their first language; to understand the publication focus of a journal; reduce the time between submission and eventual publication by helping authors submit to appropriate publications; optimize the visibility of their work to target audiences by helping authors submit to appropriate publications; understand publication specificity or breadth; optimize citation of their work by helping authors submit to the most appropriate publications; as well as improve general understanding of the publications available for their research.

Publication editors and editorial boards can use to the scope tool to: inform and support author and reader communities by providing historic and current information in graphical formats showing the content and nature of their publication focus; view publication trends in topics presented in their publications; get feedback on effects of changes in editorial direction; eliminate the need to regularly update text based Aims and Scopes; eliminate unnecessary work by promoting more relevant submissions; and better understand the content profile and type of their own publication.

Publishers can use the scope tool to develop and provide tools and processes to understand current differentiations within their publication portfolio; provide clear graphical representations comparing and contrasting their portfolio with competitor portfolios; show publication trends in topics presented in their publication portfolios; refocus existing publications and start new titles depending on coverage or gaps in their current portfolio; eliminate the need to regularly update text based Aims and Scopes; eliminate unnecessary work by promoting more relevant submissions; attract submissions by placing the scope tool on publication websites to interact with and obtain feedback from potential authors; and better redirect authors who are intending to or have submitted to an publication that might be unsuitable for their manuscript or data.

Librarians and Institutions can use the scope tool to: understanding the current publication focuses of publications and so help focus publication collections to those most relevant to an institution's members' research areas; compare publications and trending information to better inform library users; make more efficient use of library budget funds for subscriptions; and generally focus and manage their publication portfolios.

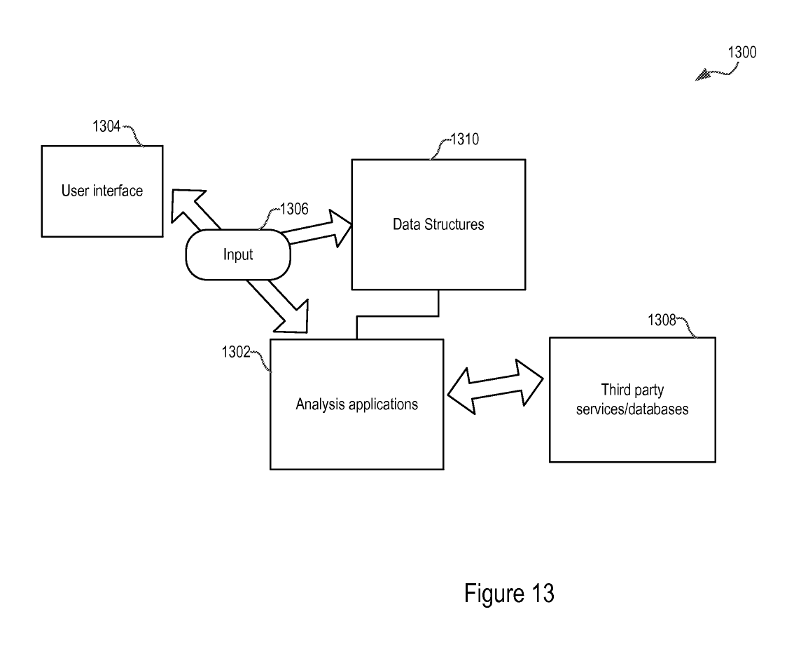

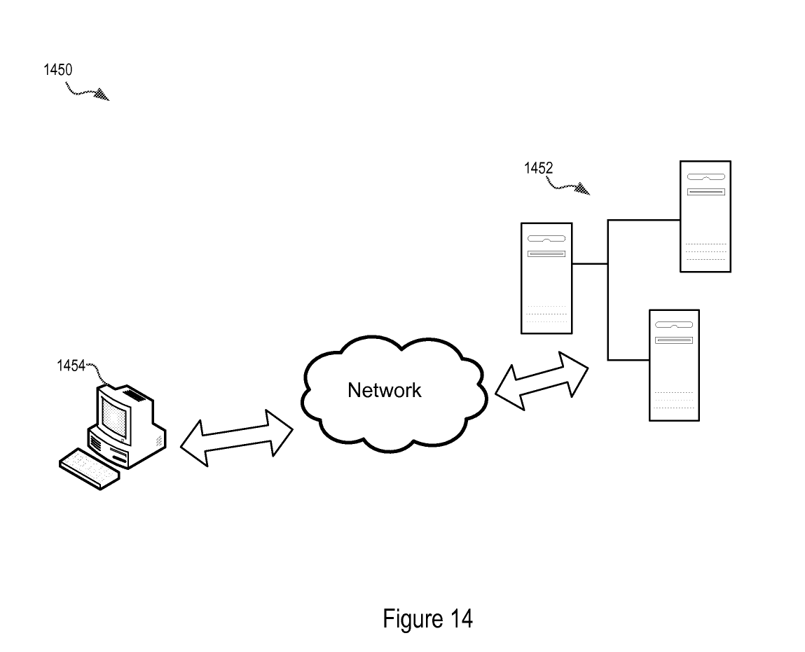

FIG. 13 shows an example environment for the scope tool 1300. The scope tool 100 may include one or more analysis applications 1302 interacting with a user interface application 1304. The analysis applications 1302 receive input submissions 106 from the user interface application 1304 and process data from one or more data structures 1310. The analysis applications 1302 analyze the input submissions 1306 e.g., with reference to data structures 1310 for example to locate synonyms for the input term or terms, and select various visualizations to present to user. Data structures 1310 are chosen to enable real time processing of input submissions 1306 by analysis applications 1302. In some implementations, the analysis applications 1302 may further contact third party services and databases 1308 to support provision of the visualizations to the user. For example, datasets, ontologies, or other informational elements used to form the basis for the presented visualizations may be access from a third party or remote database. The scope tool 1300 may run on multiple systems over a network (e.g. the Internet and/or a local network, intranet, etc.). For example, referring to the exemplary configuration 150 of FIG. 14, the analysis applications 1302 may run on a publication services provider (PSP) 1452 owned server, the user interface application 104 may run on a user terminal 1454, and the third party services and databases may run on third party servers. In various implementations, the servers 1452 and user terminals 1454 may include processors, memory, network interfaces, and/or other circuitry to support execution of the analysis application 1304 and user interface application 1302 However, it will be appreciated that the configuration of FIG. 14 is exemplary and the scope tool 1300 may be implemented in varied configurations both network-based and single system. For example, the analysis applications 1302 and user interface application 1304 may execute on a single system.

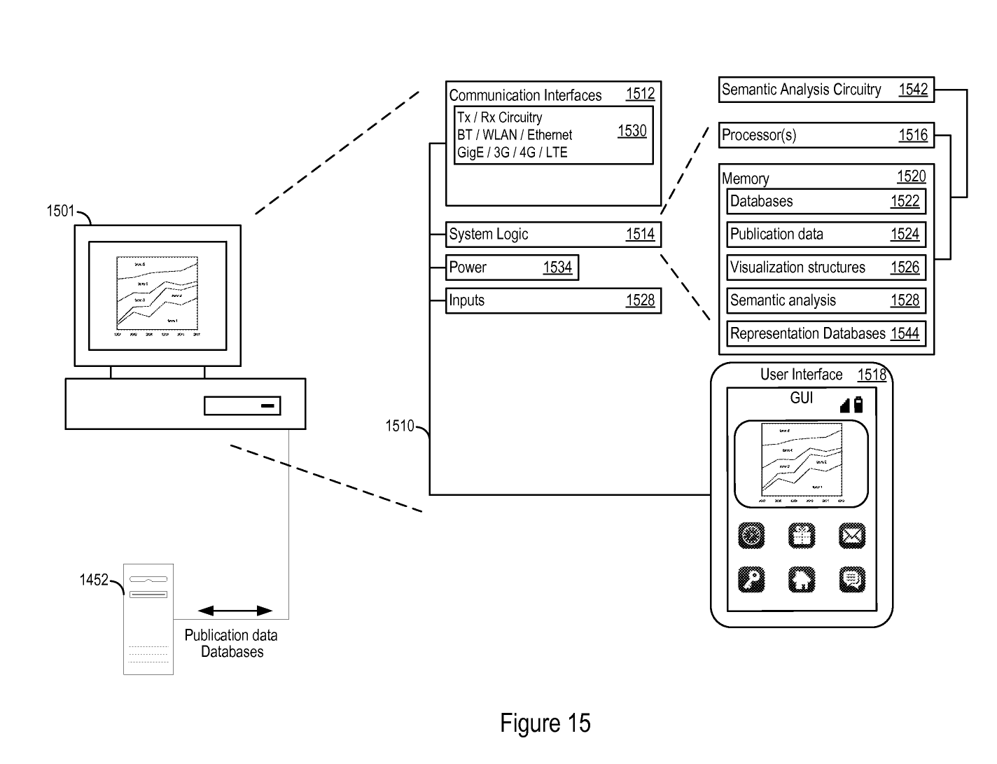

FIG. 15 shows an example specific execution environment 1501 for the scope tool and publishing focus visualizations. The execution environment 1501 may include system logic 1514 to support execution and presentation of the visualizations described above. The system logic 1514 may include processors 1516, memory 1520, and/or other circuitry, which may be used to implement the semantic analysis circuitry 1542. The memory 1520, may be used to store the databases 1522 and/or publication data 1524 used in the visualizations described above. The memory may further include applications and structures, for example, coded objects, templates, or other data structures to support generation of the visualizations. The memory may further include semantic analysis tools, such as ontologies, application programming interfaces, software packages, or other tools to support analysis of publication data and generation of databases, for example, word, N-gram, and/or other databases, which may execute on semantic analysis circuitry 1542. The memory may also include one or more representation databases 1544 for use by publishing focus query logic 1600, as discussed below. The memory may also support storage of elements obtained through external or third-party databases. The execution environment 1501 may also include commutation interfaces 1512, which may support wireless, e.g. Bluetooth, Wi-Fi, WLAN, cellular (4G, 4G, LTE/A), and/or wired, ethernet, Gigabit ethernet, optical networking protocols. The communication interface may support communication with external or third-party servers 1452. The execution environment 1501 may include power functions 1534 and various input interface 1528. The execution environment may also include a user interface 1518 that may include human interface devices and/or graphical user interfaces (GUI). The GUI may be used to present the visualizations to the user.

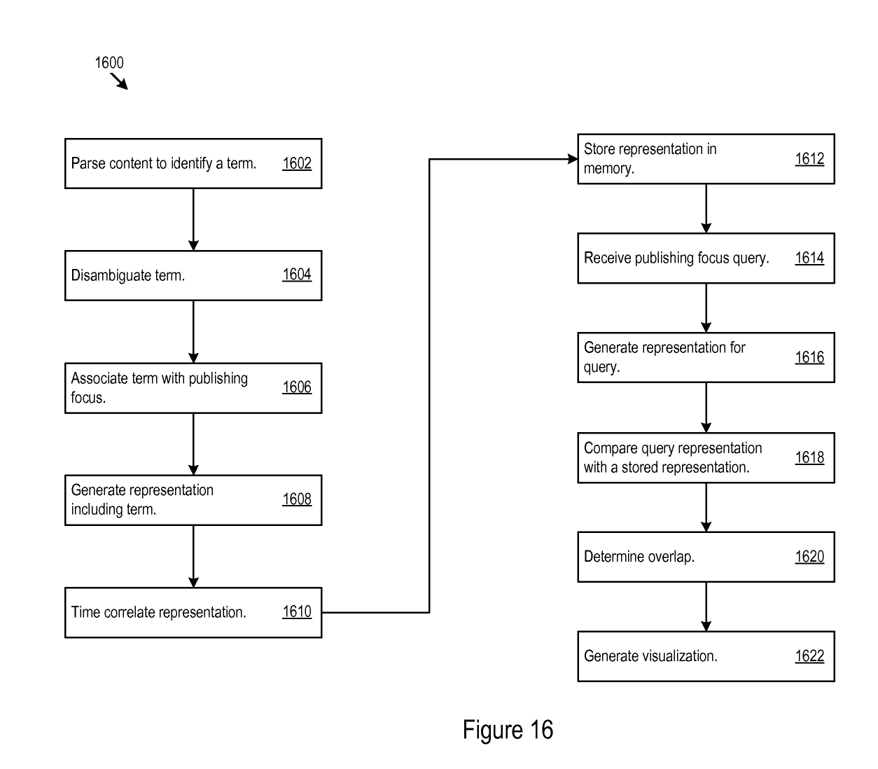

FIG. 16 shows example publishing focus query logic (PFQL) 1600, which may be executed on semantic analysis circuitry 1542. The PFQL 1600 may parse content of a publication to identify terms (1602). For example, the PFQL 1600 may reference data sets and apply ontologies to identify terms that are meaningful, e.g., indicative a subject matter topics. For example the term ‘laser physics’ may be highly meaningful in topic identification while a general term such as ‘determination’ may have little value in topic identification absent context or additional strings. The PFQL may use virtually any of the analysis tools, engines, or structures discussed above with respect to content analysis. The PFQL may apply disambiguation to the term using contextual data or metadata (1604). For example, for terms that are reused across multiple fields, a particular instance of a term may be disambiguated using neighboring terms, publication metadata, e.g., journal topic, listed article keywords, section headers, or other surrounding context as discussed above. Disambiguation may not necessarily be applied to terms if alternative uses are non-existent or uncommon. Further, in some cases, the set of possible disambiguation may point to a singular topic at the resolution level of interest. Thus, disambiguation may be forgone in some such cases.

Once the term is disambiguated, the PFQL 1600 may associate the term with one or more publishing foci (1606). For example, a term may be indicative of multiple related topics. The PFQL 1600 may associate the occurrence of the term with the multiple topics. Responsive to the identification of the publishing foci, the PFQL 1600 may include the occurrence of the term in a representation associated with the publishing focus (1608). For example, a representation may be a multi-dimensional vector or matrix that includes terms and occurrences. In some cases, occurrences may be accounted for in a magnitude element associated with a term to show frequency of occurrence.

In some implementations, a single representation may be maintained for occurrences of identified terms within a publication. In some cases, the single publication representation may be correlated with a representation a specified topic to determine whether the publication includes content related to the topic. Additionally or alternatively, the correlations may be used to rank the relative strength of given topics within a publication or a single topic across multiple publications. Thus, the representations could be used to generate visualizations such as those in discussed with respect to fingerprint, vector, prism, explorer or other visualizations.

Additionally or alternatively, representations may be time correlated by the PFQL 1600 (1610). For example, a first representation for a publication may be associated with a first time interval and a second representation for the same publication may be associated with a second time interval. Thus, the evolution of term inclusion may be mapped using the representations to generate time-based data such as that shown in e.g., visualizations 200, 700.

The representations may be stored in representation memory by the PFQL 1600 (1612). For example, the representation memory may be implemented on data structures 1310, representation databases 1544. The representations may be stored in databases according to type. For example, vector type representations may be stored in a first database. Other representations, such as keyword collections, n-grams, or other representations types may be stored in separate databases. The structure of the data for a given representation type may have benefit from a given database structure. Thus, in some cases, segregating representation types may allow for performance adjustments in representation analysis.

The PFQL 1600 may receive a publishing focus query (1614). For example, the query may be request for a comparison among publications, a request for a visualization or search for publications that include articles on a given topic. The PFQL 1600 may generate a representation for the publishing focus query (1616). For example, for a publication comparison, the PFQL may use a stored representation for the publication or publications in the query to serve as the query representation. For a topic, the PFQL 1600 may use look up table to reference a stored representation for the topic or the PFQL 1600 may reference representation databases to find representations including the topic. The PFQL 1600 may use a selected representation from the searched group or generate an averaged representation for the topic from multiple representations. In some cases, the query itself may be used as the query representation. For example, a single keyword search may be performed.

The PFQL 1600 may the compare the query representation to the one or more stored representations in the memory (1618). In some cases, the PFQL 1600 may select a representation database within the memory based on the type of the query representation. For example, a query representation may be searched against like or compatible stored representations.

The PFQL 1600 may determine a correlation or overlap between the query representation and one or more stored representations (1620). For example, an overlap may include terms for presentation within a visualization or search results. The PFQL 1600 may generate a display, e.g., a visualization or other display, based on the correlation or overlap (1622).

The methods, tools, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A method comprising:
parsing, at semantic analysis circuitry, content from a first publication to identify a first term, the first term indicative of a publishing focus of the first publication;
determining an occurrence of the first term within the content;
responsive to the publishing focus, generating a first representation of the publishing focus based on the first term and the occurrence;
storing the first representation in a representation memory;
after storing the first representation in the representation memory, receiving, via communication interface circuitry, a publishing focus query for the first publication;
responsive to the publishing focus query, generating a second representation of the focus query;
accessing the first representation in the representation memory;
comparing the first and second representations to determine an overlap between the first and second representations;
determining that the first term is within the overlap; and
generating a display output that accounts for the occurrence.

2. The method of claim 1, further comprising parsing content from the first publication to identify a second term, the second term failing to indicate any publishing focus; and
forgoing generation of a third representation based on the second term.

3. The method of claim 1, where the first representation is based on multiple terms, the multiple terms each indicative of the publishing focus.

4. The method of claim 1, where the display accounts for the occurrence by indicating a frequency with which the first term occurs within the content.

5. The method of claim 4, where the display further display accounts for the occurrence by showing relative frequencies with which the first term occurs with other terms.

6. The method of claim 4, where the frequency with which the first term occurs within the content comprises a frequency within a defined interval.

7. The method of claim 6, further comprising determining a frequency of occurrence for a second term over a second defined interval to determine a publishing focus evolution for the first publication.

8. The method of claim 1, where the publishing focus query comprises a publication topic; and
the semantic analysis circuitry is configured to generate the second representation from key terms associated with the publication topic.

9. The method of claim 1, where the first term is indicative of multiple publishing foci.

10. The method of claim 1, where the publishing focus query comprises a request for publications similar to a selected publication.

11. The method of claim 10, where the display comprises a comparison between the first publication and the selected publication.

12. The method of claim 1, where the display comprises indications of multiple publication foci for the publication.

13. The method of claim 12, where the indications comprises indications of relative sizes of portions of the content associated with the respective ones of the multiple publication foci.

14. The method of claim 1, where the display comprises a fingerprint visualization, a prism visualization, an explorer visualization, a bar graph, a pie chart, a histogram, or any combination thereof.

15. A system comprising:
communication interface circuitry configured to receive a publishing focus query for a publication;
representation memory configured to store publishing focus representations; and
semantic analysis circuitry in data communication with the communication interface circuitry and the semantic analysis circuitry, the semantic analysis circuitry configured to:
parse content from a publication to identify a first term, the first term indicative of a publishing focus of the publication;
determine an occurrence of the first term within the content;
responsive to the publishing focus, generate a first publishing focus representation based on the first term and the occurrence;
cause the representation memory to store first publishing focus representation;
responsive to the publishing focus query, generate a second publishing focus representation;
access the first publishing focus in the representation memory;
compare the first and second publishing focus representations to determine an overlap of the first and second publishing focus representations; determine that the first term is within the overlap; and
generate a display output that accounts for the occurrence.

16. The system of claim 15, where:
the representation memory comprises multiple representation databases;
the representation databases store different types of publishing focus representations; and
the semantic analysis circuitry is configured to store the first publishing focus representation in a first representation database responsive to a type of the first publishing focus representation.

17. The system of claim 16, where:
the semantic analysis circuitry is configured to access the first publishing focus representation by accessing the first representation database responsive to a type of the second publishing focus representation; and
the type of the first publishing focus representation and the type of the second publishing focus representation are the same type.

18. The system of claim 15, where the publishing focus query comprises a request for publications similar to a selected publication.

19. A system comprising:
communication interface circuitry configured to:
receive a publishing focus query for a publication; and
send an update message to a publication server;
memory configured to store publishing focus representations; and
semantic analysis circuitry in data communication with the communication interface circuitry and the semantic analysis circuitry, the semantic analysis circuitry configured to:
parse content from a publication to identify a first term, the first term indicative of a first publishing focus of the publication;
parse content from a publication to identify a second term, the second term indicative of a second publishing focus of the publication;
determine a first occurrence of the first term within the content within a first period;
responsive to the first publishing focus, generate a first publishing focus representation based on the first term and the first occurrence;
determine a second occurrence of the second term within the content within a second period;
responsive to the second publishing focus, generate a second publishing focus representation based on the second term and the second occurrence;
responsive to the publishing focus query, access the first publishing focus representation and the second publishing focus representation;
compare the first and second publishing focus representations;
after comparing the first and second publishing focus representations, generate the update message for a display, the update message comprising a publishing focus evolution for the publication during the first and second periods; and
cause the communication interface circuitry to send the update message.

20. The system of claim 19, where the update message is configured to add subject matter to a publication description stored on the publication server, remove subject matter from the publication description, or both.
